(19) United States
(12) Patent Application Publication
(10) Pub. No.: US 2026/0140823 A1
(43) Pub. Date: May 21, 2026

(54) Self-Adaptation LDPC Min-Sum Soft Decoder for Different NAND VT Distributions

(71) Applicant: SK hynix Inc., Gyeonggi-do (KR)

(72) Inventors: Pengfei HUANG, San Jose, CA (US); Fan ZHANG, San Jose, CA (US)

(21) Appl. No.: 18/948,464

(22) Filed: Nov. 15, 2024

(51) Int. Cl. G06F 11/10

(52) U.S. Cl. CPC G06F 11/1068; G06F 11/1004

(57) ABSTRACT

A method and memory system for decoding data read from a storage of a memory system. The method reads the data stored in the storage of the memory system with read voltages spanning a range of voltage threshold distributions and including voltages within each of the voltage threshold distributions. The method further divides the range into bins spanning the range; generates initial log likelihood ratio values for each bin and generating a bin sequence bn of bin positions; and adjusts values of the initial log likelihood ratio values for each bin to provide adjusted log likelihood ratio values for each bin prior to a final decoding of the data read from the storage.

### BACKGROUND

### 1. Field

The present invention relates to the processing of scrambled data in solid state drives.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices. Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD may include flash memory components and a controller, which includes the electronics that bridge the flash memory components to the SSD input/output (I/O) interfaces. The SSD controller can include an embedded processor that can execute functional components such as firmware. The SSD functional components are device specific, and in most cases, can be updated. One type of flash memory components is named NAND after the NAND logic gates in this SSD. The NAND-type flash memory may be written and read in blocks (or pages) which are generally much smaller than the entire memory space. The NAND-type operates primarily in memory cards, USB flash drives, solid-state drives, and similar products, for general storage and transfer of data.

In this context, embodiments of the present invention for processing NAND data arise.

### SUMMARY

In accordance with one embodiment of the present invention, there is provided a method for decoding data read from a storage of a memory system. The method reads the data stored in the storage of the memory system with read voltages spanning a range of voltage threshold distributions and including voltages within each of the voltage threshold distributions. The method further divides the range into bins spanning the range; generates initial log likelihood ratio values for each bin and generates a bin sequence bn of bin positions; and adjusts values of the initial log likelihood ratio values for each bin to provide adjusted log likelihood ratio values for each bin prior to a final decoding of the data read from the storage.

In accordance with another embodiment of the present invention, there is provided a memory system comprising a storage for storing data therein; an encoder for encoding the data prior to storing the data in the storage; a decoder for decoding the data after the data is read from the storage; and a controller for controlling processing of the data read from the storage. The controller is configured to: read the data stored in the storage of the memory system with read voltages spanning a range of voltage threshold distributions and including voltages within each of the voltage threshold distributions. The controller is further configured to divide the range into bins spanning the range; generate initial log likelihood ratio values for each bin and produce a bin sequence of bin positions; and adjust values of the initial log likelihood ratio values for each bin to provide adjusted log likelihood ratio values for each bin prior to a final decoding of the data read from the storage.

### BRIEF DESCRIPTION OF THE DRAWINGS

FIG. 1 is a high level block diagram illustrating an error correcting system in accordance with embodiments of the present invention.

FIG. 2 is a block diagram schematically illustrating a memory system in accordance with embodiments of the present invention.

FIG. 3 is a block diagram illustrating a memory system in accordance with embodiments of the present invention.

FIG. 4A is a circuit diagram illustrating a memory block of a memory device in accordance with embodiments of the present invention.

FIG. 4B is a diagram illustrating distributions of states for different types of cells of a memory device.

FIG. 4C is a diagram illustrating an example of Gray coding for a multi-level cell (MLC).

FIG. 5 is a diagram illustrating state distributions for pages of a multi-level cell (MLC).

FIG. 6 is a diagram illustrating an example of Gray coding for a triple-level cell (TLC).

FIG. 7 is a diagram illustrating state distributions for pages of a triple-level cell (TLC).

FIG. 8 is schematic diagram showing, in accordance with embodiments of the present disclosure, two single level cell NAND voltage distributions with an on state “1” and an off state “0” and seven soft read reads using the voltages R0 to R6.

FIG. 9 is table, in accordance with embodiments of the present disclosure, showing Gray labeling for a Quadruple Level Cell (QLC).

FIG. 10 is schematic diagram showing, in accordance with embodiments of the present disclosure, a QLC NAND least significant bit (LSB) page with sixteen voltage state distributions.

FIG. 11 is schematic diagram showing, in accordance with embodiments of the present disclosure, the QLC NAND LSB page of FIG. including three SLC assist reads.

FIG. 12 is a block diagram in accordance with embodiments of the present disclosure, showing a self-adaptation LDPC Min-Sum Soft Decoder with random-encoder (REN) Architecture.

FIG. 13 is a block diagram in accordance with embodiments of the present disclosure, showing a self-adaptation LDPC Min-Sum Soft Decoder with encoder-random (ERN) Architecture.

FIG. 14 is a flow chart illustrating a method for decoding data read from a storage of a memory system according to another embodiment of the present disclosure.

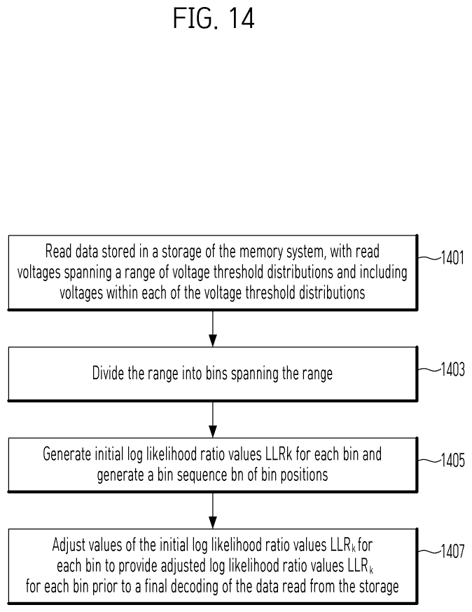

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will convey the scope of the present invention to those skilled in the art. Throughout the disclosure, like reference numerals refer to like parts throughout the various figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily suitable for performing the task at a given time or a specific component that is manufactured to perform the task. As used herein, the term ‘processor’ refers to one or more devices, circuits, and/or processing cores suitable for processing data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

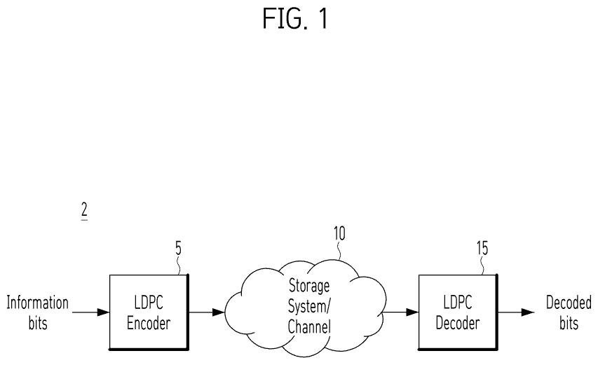

FIG. 1 is a high-level block diagram illustrating an error correcting system 2, in accordance with embodiments of the present invention. More specifically, the high-level block diagram in FIG. 1 shows error correcting system 2 including an encoder 5 and a decoder using for example LDPC coding and decoding algorithms. That is, error correcting system 2 may include a LDPC encoder 5 and a LDPC decoder 15, although other coding and decoding algorithms can be used.

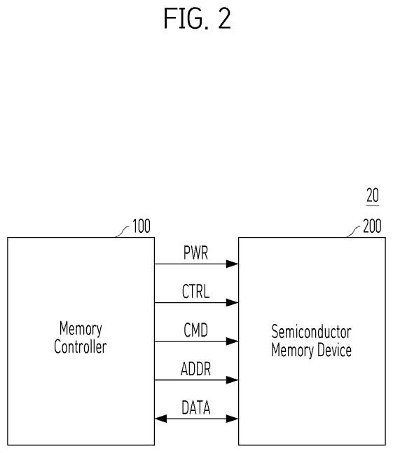

The LDPC encoder 5 may receive information bits including data which is desired to be stored in a storage system 10 (such as in memory system 20 of FIG. 2). The LDPC encoder 5 may encode the information bits to output LDPC encoded data. The LDPC encoded data from the LDPC encoder 5 may be written to a storage device or memory device of the storage system 10. In various embodiments, the storage device may include a variety of storage types or media. In some embodiments, during being written to or read from the storage device, data is transmitted and received over a wired and/or wireless channel. In this case, the errors in the received codeword may be introduced during transmission of the codeword.

When the stored data in the storage system 10 is requested or otherwise desired (e.g., by an application or user which stored the data), the LDPC decoder 15 may perform LDPC decoding of data received from the storage system 10, which may include some noise or errors. In various embodiments, the LDPC decoder 15 may perform LDPC decoding using the decision and/or reliability information for the received data. The decoded bits generated by the LDPC decoder 15 are transmitted to the appropriate entity (e.g., the user or application which requested it). With proper encoding and decoding, the information bits match the decoded bits.

When the stored data in storage system 10 is requested or otherwise desired (e.g., by an application or user which stored the data), the LDPC decoder 15 may receive data from the storage system 10. The received data may include some noise or errors. The LDPC decoder may perform detection on the received data and output decision and/or reliability information. The LDPC decoder 15 may include one of a soft detector and a hard detector. Either the soft detector or the hard detector can provide channel information for decoders, such as the LDPC decoder. For example, the soft detector may output reliability information and a decision for each detected bit. On the other hand, the hard detector may output a hard decision on each bit without providing corresponding reliability information. As an example, the hard detector may output as the hard decision that a particular bit is a “1” or a “O” without indicating how certain or sure the detector is in that decision. In contrast, the soft detector may output a decision and reliability information associated with the decision. In general, reliability information indicates how certain the detector is in a given decision. In one example, a soft detector may output a log-likelihood ratio (LLR) where the sign indicates the decision (e.g., a positive value corresponds to a “1” decision and a negative value corresponds to a “0” decision) and the magnitude indicates how sure or certain the detector is in that decision (e.g., a large magnitude indicates a high reliability or certainty).

LDPC decoder 15 may perform LDPC decoding using the decision and/or reliability information. The decoded bits generated by the LDPC decoder 15 can be transmitted to the appropriate entity (e.g., the user or application which requested it). With proper encoding and decoding, the information bits match the decoded bits.

In LDPC decoding, a syndrome update may check to see if all of the errors have been removed from a codeword containing user data or bit data. For example, if for the parity check matrix H, the LDPC checksum ĉH=0, then the syndrome update can determine that decoding is successful and all errors have been removed from the codeword. If so, the LDPC decoding stops decoding and outputs ĉ=[ĉ1, ĉ2, . . . ĉ N] as the decoded output.

If the LDPC checksum is not equal to zero, the decoded codeword (i.e., ĉ) is not output and another decoding iteration is performed until a maximum number of iterations, which may be predefined, is reached. In other words, a variable node update calculates new variable to check node (V2C) messages and new log likelihood ratios (LLR) values, the check node update calculates new check to variable node (C2V) messages, and the codeword update calculates a new codeword and checks if the product of the new codeword and the parity check matrix is 0, that is ĉH=0.

If a correct codeword is not found, the iterations continue with another update from the variable nodes using the messages that they received from the check nodes to decide if the bit at their position should be a zero or a one by a majority rule. The variable nodes then send this hard decision message to the check nodes that are connected to them. The iterations continue until a correct codeword is found.

In some embodiments, an LDPC decoding operation may be performed according to bit flipping decoding. In bit-flipping decoders, the decoder may process a fixed number W of variable nodes (VN) in one clock-cycle. That is for each of the VNs to be processed in a cycle, the decoder counts the number of neighboring check nodes (CN) that are unsatisfied and compares this number with a threshold T. If the count is larger than the threshold T, the decoder flips the current bit-value of the VN. The variable nodes are typically each processed one-by-one from the first variable node to the last variable node.

FIG. 2 is a block diagram schematically illustrating a memory system 20 in accordance with one embodiment of the present invention.

Referring FIG. 2, the memory system 20 may include a memory controller 100 and a semiconductor memory device 200.

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal may include a command latch enable (CLE) signal, an address latch enable (ALE) signal, a chip enable (CE) signal, a write enable (WE) signal, a read enable (RE) signal, and so on.

The memory controller 100 and the semiconductor memory device 200 may be integrated in a single semiconductor device. For example, the memory controller 100 and the semiconductor memory device 200 may be integrated in a single semiconductor device such as a solid state drive (SSD). The solid state drive may include a storage device such as a NAND memory for storing data therein.

The memory controller 100 and the semiconductor memory device 200 may be integrated in a single semiconductor device such as a memory card. For example, the memory controller 100 and the semiconductor memory device 200 may be integrated in a single semiconductor device configured to have a memory card such as a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), or a universal flash storage (UFS).

In another example, the memory system 20 may be provided as one of various elements including an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, one of electronic devices of a home network, one of electronic devices of a computer network, one of electronic devices of a telematics network, a radio-frequency identification (RFID) device, or elements devices of a computing system.

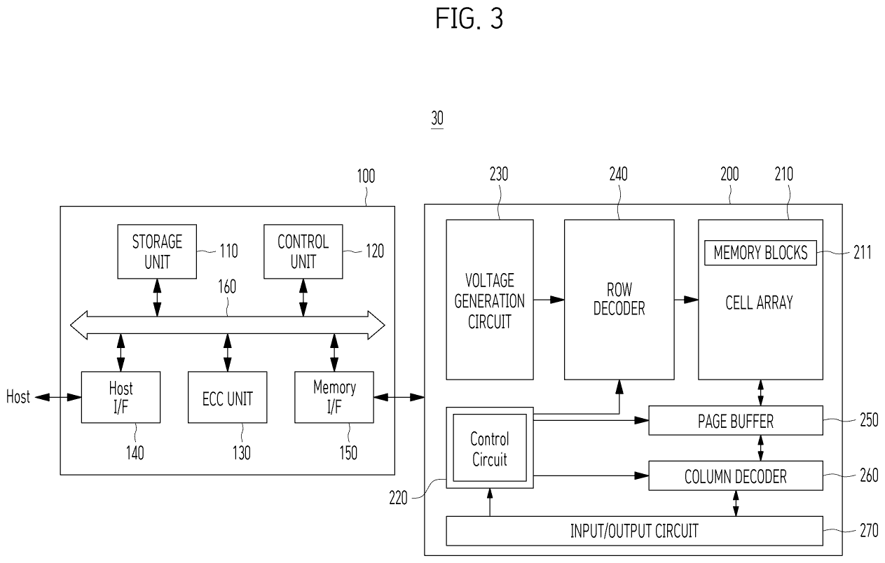

FIG. 3 is a detailed block diagram illustrating various embodiments of memory system 30. For example, memory system 30 of FIG. 3 may depict the storage system 10 shown in FIG. 1 or the memory system 20 shown in FIG. 2.

Referring to FIG. 3, the memory system 30 may include the memory controller 100 and the semiconductor memory device 200. The memory system 30 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, a digital video recorder or a digital video player. In some embodiments, the host device may include a portable electronic device such as a mobile phone, a smart phone, an e-book, an MP3 player, a portable multimedia player (PMP), or a portable game player.

The memory device 200 may store data to be accessed by the host device.

The memory device 200 may be implemented with various memory devices such a NAND flash memory, which is particularly advantageous for reasons noted below, but the present invention is not so limited and other volatile and non-volatile memory devices may be used such as for example a dynamic random access memory (DRAM) and a static random access memory (SRAM), a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The controller 100 may control storage of data in the memory device 200. For example, the controller 100 may control the memory device 200 in response to a request from the host. The controller 100 may provide the data read from the memory device 200, to the host, and store the data provided from the host into the memory device 200. In one embodiment, especially for NAND flash based memory systems, controller 100 may include a scrambler for scrambling data, which is to be written to the memory device 200, and a descrambler for descrambling data, which is read from the memory device 200.

The controller 100 may include a storage unit 110, a control unit 120, the error correction code (ECC) unit 130, a host interface 140 and a memory interface 150, which are coupled through a bus 160.

The storage unit 110 may serve as a working memory of the memory system 10 and the controller 100, and store data for driving the memory system 10 and the controller 100. When the controller 100 controls operations of the memory device 200, the storage unit 110 may store data used by the controller 100 and the memory device 200 for such operations as read, write, program and erase operations.

The storage unit 110 may be implemented with a volatile memory. The storage unit 110 may be implemented with a static random access memory (SRAM) or a dynamic random access memory (DRAM). As described above, the storage unit 110 may store data used by the host device in the memory device 200 for the read and write operations. To store the data, the storage unit 110 may include a program memory, a data memory, a write buffer, a read buffer, a map buffer, and so forth.

Referring to FIG. 3, the control unit 120 may control general operations of the memory system 30, and a write operation or a read operation for the memory device 200, in response to a write request or a read request from the host device. The control unit 120 may drive firmware, which is referred to as a flash translation layer (FTL), to control the general operations of the memory system 10. For example, the FTL may perform operations such as logical to physical (L2P) mapping, wear leveling, garbage collection, and bad block handling. The L2P mapping is known as logical block addressing (LBA).

The ECC unit 130 may detect and correct errors in the data read from the memory device 200 during the read operation. The ECC unit 130 may not correct error bits when the number of the error bits is greater than or equal to a threshold number of correctable error bits, and may output an error correction fail signal indicating failure in correcting the error bits.

In some embodiments, the ECC unit 130 may perform an error correction operation based on a coded modulation such as an LDPC code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), a Block coded modulation (BCM), and so on. The ECC unit 130 may include all circuits, systems or devices for the error correction operation.

As shown in FIG. 3, host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), or an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control unit (e.g., CPU) 120. When the memory device 200 is a flash memory such as a NAND flash memory, the memory interface 150 may generate control signals for the memory and process data under the control of the control unit 120.

The memory device 200 may include a memory cell array 210, a control circuit 220, a voltage generation circuit 230, a row decoder 240, a page buffer 250, a column decoder 260, and an input/output circuit 270. The memory cell array 210 may include a plurality of memory blocks 211 and may store data therein. The voltage generation circuit 230, the row decoder 240, the page buffer 250, the column decoder 260 and the input/output circuit 270 form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages having various levels. For example, in an erase operation, the voltage generation circuit 230 may generate operation voltages having various levels such as an erase voltage and a pass voltage.

The row decoder 240 may be connected to the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks among the plurality of memory blocks 211.

The page buffer 250 may be connected to the memory cell array 210 through bit lines BL (not shown). The page buffer 250 may precharge the bit lines BL with a positive voltage, transmit/receive data to/from a selected memory block in program and read operations, or temporarily store transmitted data, in response to a page buffer control signal generated by the control circuit 220.

The column decoder 260 may transmit/receive data to/from the page buffer 250 or transmit/receive data to/from the input/output circuit 270.

The input/output circuit 270 may transmit, to the control circuit 220, a command and an address, transmitted from an external device (e.g., the memory controller 100), transmit data from the external device to the column decoder 260, or output data from the column decoder 260 to the external device, through the input/output circuit 270. The control circuit 220 may control the peripheral circuit in response to the command and the address.

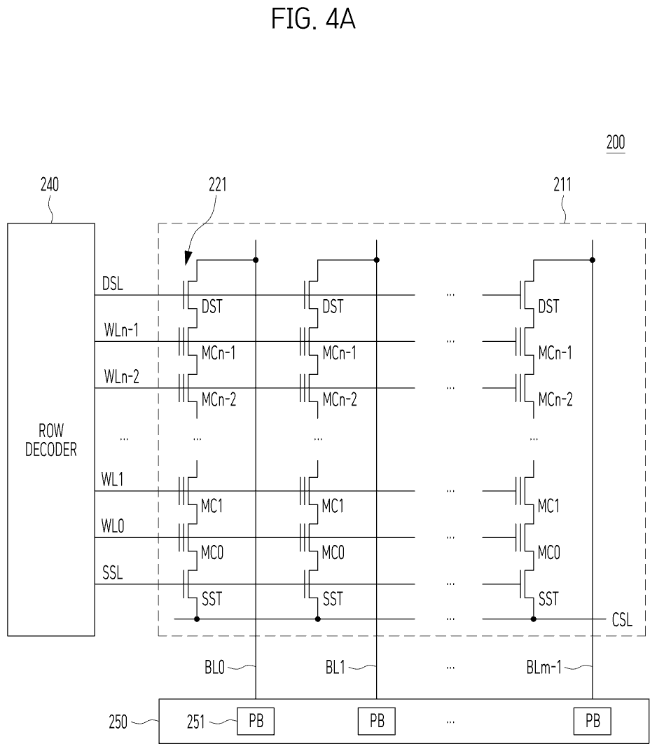

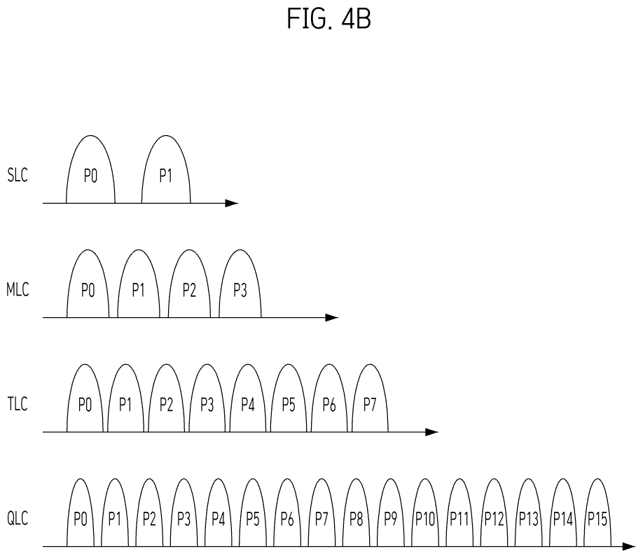

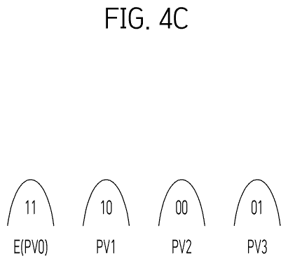

FIG. 4A is a circuit diagram illustrating a memory block of a semiconductor memory device in accordance with an embodiment of the present invention. For example, a memory block of FIG. 4 may be the memory blocks 211 of the memory cell array 210 shown in FIG. 3.

Referring to FIG. 4A, the memory blocks 211 may include a plurality of cell strings 221 coupled to bit lines BL0 to BLm-1, respectively. The cell string of each column may include one or more drain selection transistors DST and one or more source selection transistors SST. A plurality of memory cells or memory cell transistors may be serially coupled between the selection transistors DST and SST.

Each of the memory cells MC0 to MCn-1 may be formed of a multi-level cell (MLC) storing data information of multiple bits in each cell. The cell strings 221 may be electrically coupled to the corresponding bit lines BL0 to BLm-1, respectively.

The page buffer 250 may include a plurality of separate page buffers PB 251 that are coupled to the bit lines BL0 to BLm-1. The page buffers PB 251 may operate in response to page buffer control signals. For example, the page buffers PB 251 my temporarily store data received through the bit lines BL0 to BLm-1 or sense voltages or currents of the bit lines during a read or verify operation.

FIG. 4B is a diagram illustrating distributions of states or program voltage (PV) levels for different types of cells of a memory device.

Referring to FIG. 4B, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states P0 and P1. P0 may indicate an erase state, and P1 may indicate a program state. Since the SLC can be set in one of two different states, each SLC may program or store 1 bit according to a set coding method. An MLC may include four states P0, P1, P2 and P3. Among these states, P0 may indicate an erase state, and P1 to P3 may indicate program states. Since the MLC can be set in one of four different states, each MLC may program or store two bits according to a set coding method. A TLC may include eight states P0 to P7. Among these states, P0 may indicate an erase state, and P1 to P7 may indicate program states. Since the TLC can be set in one of eight different states, each TLC may program or store three bits according to a set coding method. A QLC may include 16 states P0 to P15. Among these states, P0 may indicate an erase state, and P1 to P15 may indicate program states. Since the QLC can be set in one of sixteen different states, each QLC may program or store four bits according to a set coding method.

Referring back to FIGS. 2 and 3, the memory device 200 may include a plurality of memory cells (e.g., NAND flash memory cells). The memory cells are arranged in an array of rows and columns as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is asserted. During a read operation, the word line is again asserted, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an MSB page, a center most significant bit (CMSB) page, a center least significant bit (CLSB) page and an LSB page. The multiple pages may include an upper significant bit (USB) page. The memory cells may be programmed using a coding scheme (e.g., Gray coding) in order to increase the capacity of the memory system 10 such as SSD.

FIG. 4C is a diagram illustrating an example of coding for a multi-level cell (MLC).

Referring to FIG. 4C, an MLC may be programmed using a set coding. An MLC may have 4 program states, which include an erased state E (or PV0) and a first program state PV1 to a third program state PV3. The erased state E (or PV0) may correspond to “11.” The first program state PV1 may correspond to “10.” The second program state PV2 may correspond to “00.” The third program state PV3 may correspond to “01.”

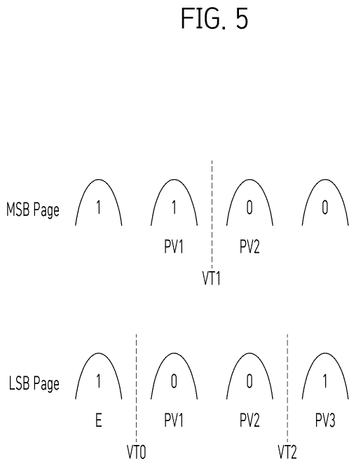

In the MLC, as shown in FIG. 5, there are 2 types of pages including LSB and MSB pages. 1 or 2 thresholds may be applied in order to retrieve data from the MLC. For an MSB page, the single threshold value is VT1. VT1 distinguishes between the first program state PV1 and the second program state PV2. For an LSB page, 2 thresholds include a threshold value VT0 and a threshold value VT2. VT0 distinguishes between the erased state E and the first program state PV1. VT2 distinguishes between the second program state PV2 and the third program state PV3.

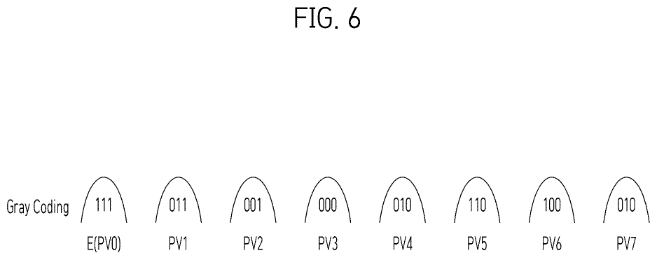

FIG. 6 is a diagram illustrating an example of Gray coding for a triple-level cell (TLC).

Referring to FIG. 6, a TLC may be programmed using Gray coding. A TLC may have 8 program states, which include an erased state E (or PV0) and a first program state PV1 to a seventh program state PV7. The erased state E (or PV0) may correspond to “111.” The first program state PV1 may correspond to “011.” The second program state PV2 may correspond to “001.” The third program state PV3 may correspond to “000.” The fourth program state PV4 may correspond to “010.” The fifth program state PV5 may correspond to “110.” The sixth program state PV6 may correspond to “100.” The seventh program state PV7 may correspond to “101.”

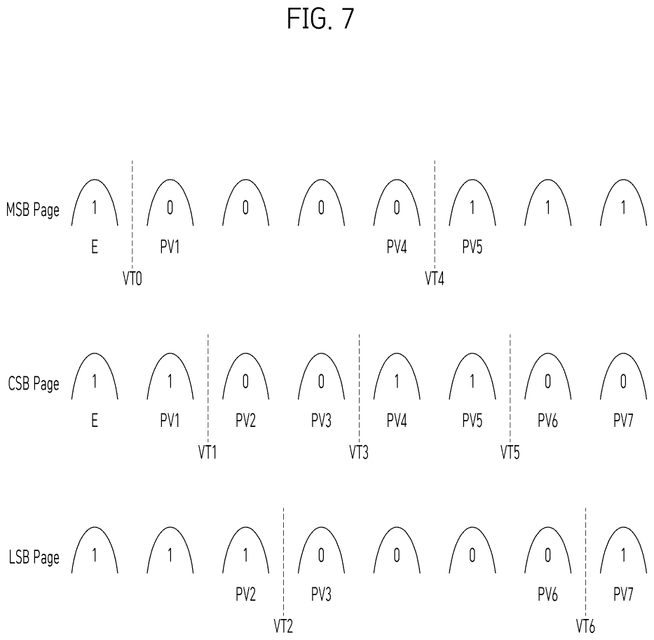

In the TLC, as shown in FIG. 7, there are 3 types of pages including LSB, CSB and MSB pages. 2 or 3 thresholds may be applied in order to retrieve data from the TLC. For an MSB page, 2 thresholds include a threshold value VT0 that distinguishes between an erase state E and a first program state PV1 and a threshold value VT4 that distinguishes between a fourth program state PV4 and a fifth program state PV5. For a CSB page, 3 thresholds include VT1, VT3 and VT5. VT1 distinguishes between a first program state PV1 and a second program state PV2. VT3 distinguishes between a third program state PV3 and the fourth program state PV4. VT5 distinguishes between the fourth program state PV5 and the sixth program state PV6. For an LSB page, 2 thresholds include VT2 and VT6. VT2 distinguishes between the second program state PV2 and the third program state PV3. VT6 distinguishes between the sixth program state PV6 and a seventh program state PV7.

After a memory array including a plurality of memory cells is programmed as described above, when a read operation is performed on the memory array using a certain voltage reference value such as a read threshold (i.e., read voltage level), the electrical charge levels of the memory cells (e.g., threshold voltage levels of transistors of memory cells) are compared to one or more voltage reference values (also called “read voltage level” or “read threshold”) to determine the state of individual memory cells. When a certain read threshold is applied to the memory array, those memory cells that have threshold voltage levels higher than the certain voltage reference value are turned on and detected as “on” cell, whereas those memory cells that have threshold voltage levels lower than the certain voltage reference value are turned off and detected as “off” cell, for example. Therefore, each read threshold is arranged between neighboring threshold voltage distribution windows corresponding to different programmed states so that each read threshold can distinguish such programmed states by turning on or off the memory cell transistors.

When a read operation is performed on memory cells in a data storage device using MLC technology, the threshold voltage levels of the memory cells are compared to more than one read threshold level to determine the state of individual memory cells. Read errors can be caused by distorted or overlapped threshold voltage distribution. An ideal memory cell threshold voltage distribution can be significantly distorted or overlapped due to, e.g., program and erase (P/E) cycle, cell-to-cell interference, and data retention errors. For example, as program/erase cycles increase, the margin between neighboring threshold voltage distributions of different programmed states decreases and eventually the distributions start overlapping. As a result, the memory cells with threshold voltages that fall within the overlapping range of the neighboring distributions may be read as being programmed to a value other than the original targeted value and thus cause read errors. Such read errors may be managed in most situations by using error correction codes (ECC). When the number of bit errors on a read operation exceeds the ECC correction capability of the data storage, the read operation fails.

Certain circumstances or operation conditions, such as charge leakage over time and device usage wear, can cause threshold voltages shift. Such a threshold voltage shift can produce read errors because several “off” cells may result in a threshold voltage higher than the read threshold due to the threshold voltage shift. Various circumstances can cause the threshold voltage shift to produce read errors. For example, memory devices with low endurance can produce more read errors than those with high endurance. Such a threshold voltage shift can be induced by operating conditions such as increased number of program/erase cycles of the memory array and increased operating temperature of the data storage devices. A read disturbance and the location of a memory chip or memory block may also be considered to determine whether the threshold voltage shift is likely to occur.

The endurance of a flash memory may indicate the maximum number of program/erase operations that the flash memory is able to perform successfully. Each memory cell can only be programmed and erased a limited number of times, before it becomes potentially unusable. In some embodiments, the endurance of a flash memory indicates the maximum number of program/erase operations per set period, e.g., day. The endurance of the flash memories can be affected by structural issues such as high memory densities and operating conditions such as high program voltages.

Data retention may refer to an operating condition relating to how long memory cells maintain a correct programmed state. Data retention can vary depending on the operating temperature and the number of program/erase cycles performed on the memory cells. Subjecting memory cells subject to high temperature and a large number of program/erase operations tends to lower their data retention.

The read disturbance indicates a phenomenon where reading data from a flash cell can cause the threshold voltages of other unread cells in the same block to shift to a different (e.g., higher) value. While a single threshold voltage shift is small, when read operations are performed over time, the threshold voltage shift eventually becomes large enough to alter the states of the memory cells.

In some embodiments, the read thresholds may be modified based on operating conditions that contribute to read errors. These operating conditions include, but are not limited to, the endurance of a memory device, data retention, read disturbance, age of the associated storage device, operating temperature of the data storage device, and the location of the memory cell to be read, which can be indicated by die indices, block indices, and/or word line indices.

The performance (e.g., input/output operations per second and throughput) of a data storage device such as an SSD is heavily dependent on the read threshold setting (i.e., read voltage setting) applied when the first read operation is conducted. If the read threshold is not optimized, the performance may be degraded because such unoptimized read threshold voltages can cause read errors. The optimization of the read threshold voltages depends on certain operating conditions such as physical location of data, device endurance, data retention time, operating temperature, read disturbance, and age of device.

As background, in an SSD, LDPC soft decoding plays an important role to guard the NAND reliability. The inventors have observed that the LDPC soft correction capability is degraded when a NAND is in stressed conditions, like end of life (EOL) high temperature data retention, EOL high read disturb, because the NAND VT distributions become asymmetric and widen in such conditions, unlike a standard Gaussian distribution shape at the beginning of life (BOL).

To achieve a high correction capability for soft decoding, the log-likelihood ratio (LLR) value of each bin based on soft reads should match the NAND VT distribution, which varies during the SSD runtime; otherwise the LDPC soft correction capability will be reduced.

Accordingly, one embodiment of the present disclosure provides a novel LDPC min-sum soft decoding architecture that can improve correction capability and reduce decoding latency. With this soft decoding architecture, the LLR value of each bin can be automatically adapted according to different NAND VT distributions by utilizing intermediate decoder information taken during the decoding process. This soft decoding architecture can work for NAND soft reads (with or without additional assist reads). The soft decoding architecture is compatible with both Randomizer-Encoder-NAND (REN) architecture and Encoder-Randomizer-NAND (ERN) architecture.

### LDPC Check Sum

For an LDPC code with m×n parity-check matrix H, the check sum (CS) computation of a length-n noisy codeword r can be expressed as follows: 1) SYND=rH^{T}; 2) CS is the number of 1's in the vector SYND.

### Bin Label and LLR

In general, a bin label is generated for each bin according to NAND soft reads. Consider for example a total of K bin labels, denoted by 0, 1, 2, . . . , K−1. The so-called log-likelihood ratio (LLR) of bin i is defined as:

$$LLR ( i ) = log ( \frac{p ( y = i / x = 0 )}{p ( y = i / x = 1 )} ) ,$$

where i=0, 1, 2, . . . , K−1, x is the sent data (bit value) stored in a memory cell and y is the received bin label data that is generated according to the soft reads on the memory cell. A larger K provides better bin resolution. For example, K can be 8 or 32 in the following examples. The LLR of each bin represents reliability information associated with a decision on how certain the bin label data (read with the voltages in that bin) is correct (e.g., as noted above a large magnitude indicates a high reliability or certainty that the bit value read is correct).

### SLC NAND 7 Reads

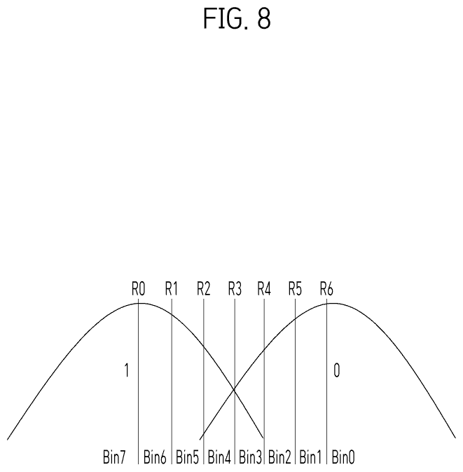

In one example of this process, FIG. 8 shows SLC NAND with seven (7) soft reads (R0, R1, . . . , R6). The seven reads R0, R1, . . . , R6 divide the whole voltage range into eight (8) bins, labeled as Bin0, Bin1, . . . , Bin7.

### QLC Nand 7 Reads

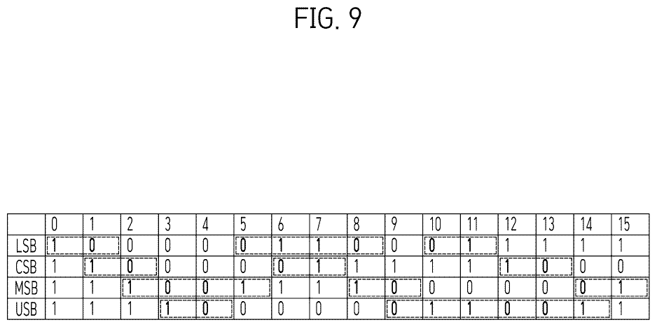

Consider the states of a QLC NAND an example. A QLC NAND as shown in FIG. 4B has 16 states P0, P1, P2, . . . , P15. A QLC NAND has four page types LSB, CSB, MSB, and USB. An example of gray labeling of QLC NAND is shown in FIG. 9.

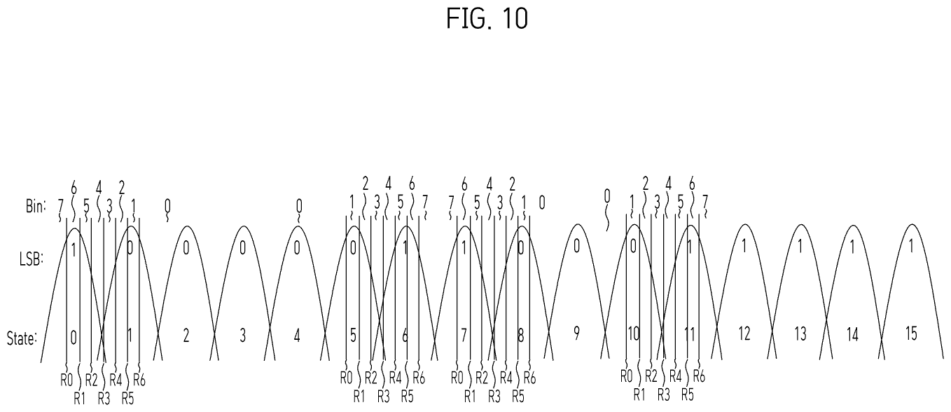

Regarding the soft reads, consider the QLC LSB page as an example as shown in FIG. 10. The seven (7) reads can divide the whole cell voltage range into 8 regions, and each region is referred to as a bin. The 8 bins are labeled as bin0, bin1, bin2, . . . , bin7.

QLC NAND 7 Reads with Assist Reads:

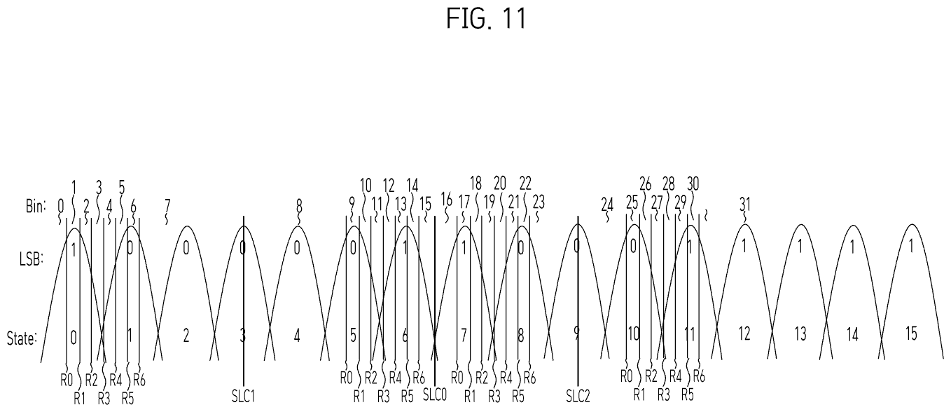

Besides the seven (7) reads, extra assist reads can be used in one embodiment to provide a better bin resolution, i.e., more bins. For example, consider the QLC LSB page as an example as shown in FIG. 11. In this example, seven (7) reads R0, R1, . . . , R6, together with three (3) SLC assist reads, SLC0, SLC1, and SLC2 are performed. All these reads can divide the whole cell voltage range into 32 regions. Each region is labeled as a bin.

Self-Adaptation LDPC Min-Sum Soft Decoder with REN Architecture

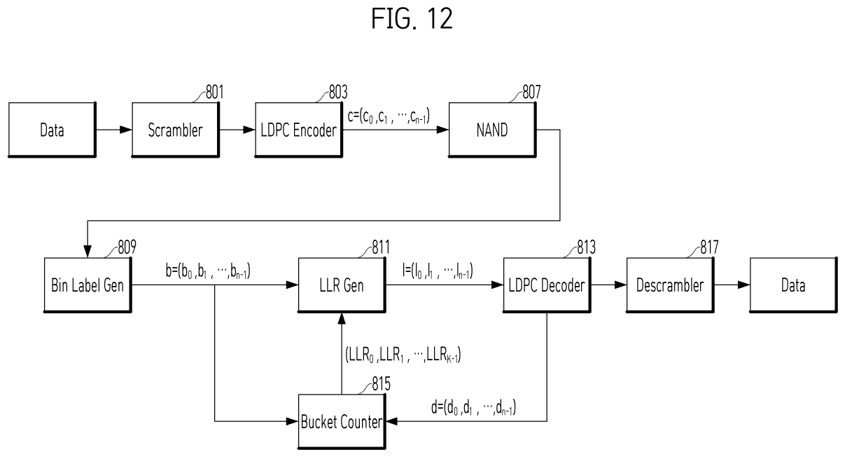

An LDPC min-sum soft decoder architecture according to one embodiment of the present disclosure is shown in FIG. 12 having a Randomizer-Encoder-NAND (REN) architecture. In this REN architecture, a scrambler (or randomizer) 801 is before an LDPC encoder 803, and a descrambler 817 is after an LDPC decoder 813.

The data is encoded by the LDPC encoder 803 to generate a codeword c=(c₀, c₁, . . . , cₙ₋₁) which as shown in FIG. 12 is sent and stored in NAND 807. For reading and decoding the data stored in NAND 807, NAND soft read data first goes through a bin label generator 809 to generate a sequence of bin labels, b=(b₀, b₁, . . . , bₙ₋₁), where element of b belongs to the set (0, 1, 2, . . . , K−1). Here 0 stands for bin0, 1 represents bin1, . . . , etc. An LLR generator 811 receives the bin set and assigns each bin an initial LLR value indicating a probability that correct bit value (“0” or “1” as illustrated in FIG. 10) will be read for each bin. For example, a bin at state 5 shown in FIG. 10 would have a high probability of reading a “0” bit value (the correct value), and low probability of reading a “1” (the incorrect bit value). Meanwhile, a bin at state 6 shown in FIG. 10 would have a high probability of reading a “1” bit value (the correct value), and a low probability of reading a “0” bit value (the incorrect bit value). The LDPC decoder 813 uses the initial LLR values to produce an intermediate decoded sequence d= (d₀, d₁, . . . , dₙ₋₁). A bucket counter 815 uses the intermediate decoded sequence d=(d₀, d₁, . . . , dₙ₋₁) and the bin label sequence b to estimate optimal (or otherwise updated) LLRs for each bin. The LLR estimation and update can be conducted under conditions determined offline. As shown in FIG. 12, the updated LLRs are provided back to the LLR generator 811 which will then be used for subsequent decoding by the LDPC decoder 813 of data read from the memory. In the REN architecture of FIG. 12, data output from the LDPC decoder 813 can be supplied to the descrambler 817 and then provided for example to a host which had requested the data.

Self-Adaptation LDPC Min-Sum Soft Decoder with REN Architecture:

Step 1. Receive at LLR generator 811 via bin label generator 809 a bin label sequence of length n from NAND soft reads (with or without assist reads), i.e., b=(b₀, b₁, . . . , bₙ₋₁) where each element belongs to the set (0, 1, 2, . . . , K−1).

Step 2. Initialize via LLR generator 811 LLR₀, LLR₁, . . . , LLR_{K-1} for Bin0, Bin1, . . . , BinK-1.

Step 3. Generate at LLR generator 811 a channel LLR sequence (meaning an LLR sequence from a noisy channel of a memory storage) l=(l₀, l₁, . . . , lₙ₋₁) by applying LLR₀, LLR₁, . . . , LLR_{K-1} to the bin label sequence b as follows:

```
For i = 0: n−1
    lᵢ = LLR_{b}_{ᵢ}
  END
```

Step 4. For iter=0 to ITER_Max:
a. Conduct at LDPC decoder 813 LDPC Min-Sum soft decoding with LLR sequence I to generate a decoded sequence d=(d₀, d₁, . . . , dₙ₋₁).
b. Calculate at LDPC decoder 813 CS using the bit sequence d.
c. IF CS==0 or iter==ITER_Max:
   Terminate decoding
END
d. IF CS<a predetermined threshold α, and iter >a predetermined threshold β and iter % γ==0:
   Compute at bucket counter 815 numbers B (0, 0), B (1, 0), B (0, 1), B (1, 1), . . . , B (0, K-1), and B (1, K-1)
where
   B (0, j) is the number of positions in sequences d and b such that dᵢ=0 and bᵢ=j, i=0, 1, . . . , . . . , n−1, j=0, 1, . . . , . . . , K−1
   B (1, j) is the number of positions in sequences d and b such that dᵢ=1 and bᵢ=j, i=0, 1, . . . , . . . , n−1, j=0, 1, . . . , . . . , K−1
   Generate via bucket counter 815 which counts the number of identifiable patterns existing between the two sequences d and b,

$${LLR}_{j} = Round ( Log ( \frac{B ( 0 , j )}{B ( 1 , j )} ) ) ,$$

j=0, 1, . . . , . . . , K−1, where “Round” is a mathematical operation that returns the value of a number rounded to the nearest integer.
   Update at LLR Generator 811 the LLR sequence l=(l₀, l₁, . . . , lₙ₋₁) by applying the updated LLR₀, LLR₁, . . . , LLR_{K-1} to the bin label sequence b as follows:

```
    For i = 0: n−1
      lᵢ = LLR_{b}_{ᵢ}
    END
  END
END
```

In one embodiment of the present disclosure, the predetermined checksum threshold α, the iteration threshold β, and the LLR update frequency γ can be determined offline.

Self-Adaptation LDPC Min-Sum Soft Decoder with ERN Architecture

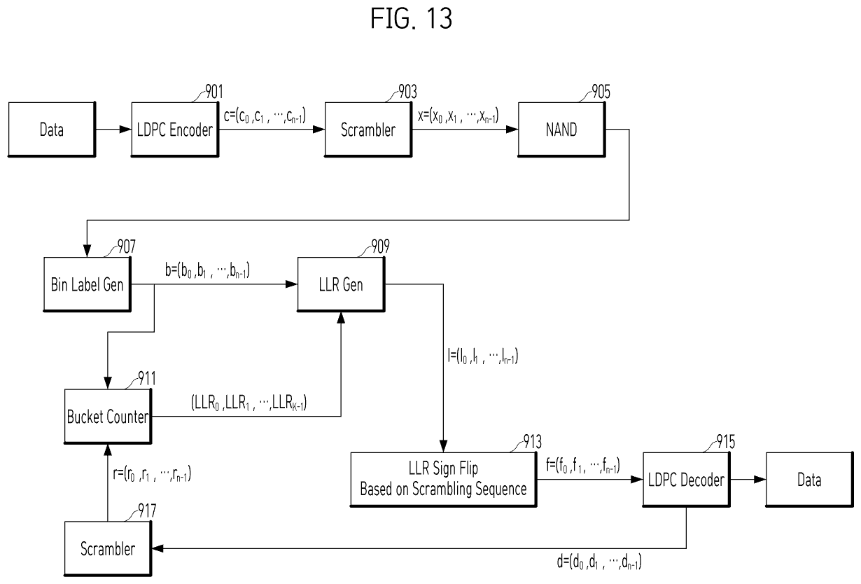

An LDPC min-sum soft decoder architecture according to one embodiment of the present disclosure is shown in FIG. 13 having a Encoder-Randomizer-NAND (ERN) architecture. In FIG. 13, data to be stored in NAND 905 is encoded by an LDPC encoder 901 and then scrambled by a scrambler (or randomizer) 903 before being stored in NAND 905. Let s=(s₀, s₁, . . . , sₙ₋₁) be a scrambling sequence used by scrambler 903. Scrambler 903 generates a sequence x=(x₀, x₁, . . . , xₙ₋₁), where x=bitwise_xor (c, s). This sequence is provided to NAND 905. For reading and decoding the data stored in NAND 905, NAND soft read data first goes through a bin label generator 907 to generate a sequence of bin labels, b=(b₀, b₁, . . . , bₙ₋₁), where each element of b belongs to the set (0, 1, 2, . . . , K−1). Here, 0 stands for bin0, 1 represents bin1, . . . , etc. A LLR generator 909 and a bucket counter 911 of FIG. 13 operate similarly to that described above for FIG. 12 although their inputs are different. LLR generator 909 receives the bin set from bin label generator 907 and assigns each bin an initial LLR value. LLR sign flipper 913 flips the signs of LLR values based on the scrambling sequence to produce a flipped sequence f=(f₀, f₁, . . . , fₙ₋₁). The flipped sequence f is provided to LDPC decoder 915. LDPC decoder 915 uses the flipped sequence of LLR values to produce an intermediate decoded sequence d=(d₀, d₁, . . . , dₙ₋₁), which is provided to scrambler 917. Bucket counter 911 also receives the bin label sequence from bin label generator 907, receives a scrambled sequence from scrambler 917, and modifies the initially-assigned LLRs to produce an updated set of LLRs for each bin.

The updated LLRs are provided back to the LLR generator 909 which will then be used for subsequent decoding by the LDPC decoder 915 of data read from the memory. In the ERN architecture of FIG. 13, data output from the LDPC decoder 915 can be provided for example to a host which had requested the data.

With the ERN architecture in FIG. 13, the steps described earlier for the self-adaptation min-sum soft decoder in FIG. 12 are adjusted as follows:

Step 1. Receive at LLR generator 909 via bin label generator 907 a bin label sequence of length n from NAND soft reads (with or without assist reads), i.e., b=(b₀, b₁, . . . , bₙ₋₁) where each element belongs to the set (0, 1, 2, . . . , K−1).

Step 2. Using LLR generator 909, initialize LLR₀, LLR₁, . . . , LLR_{K-1} for Bin0, Bin1, . . . , Bink-1.

Step 3. Generate by LLR generator 909 a channel LLR sequence l=(l₀, l₁, . . . , lₙ₋₁) by applying LLR₀, LLR₁, . . . , LLR_{K-1} to the bin label sequence b as follows:

```
For i = 0: n−1
    lᵢ = LLR_{b}_{ᵢ}
  END
```

Step 4. Generate via LLR sign flipper 913 a flipped LLR sequence f=(f₀, f₁, . . . , fₙ₋₁) by LLR Sign Flip 913 as follows:

```
  For i = 0: n−1
    IF scrambling sequence bit sᵢ = = 1 : fᵢ = −lᵢ
    ELSE: fᵢ = lᵢ
    END
END
```

Step 5. For iter=0: ITER_Max:
a. Conduct with LDPC decoder 915 Min-Sum soft decoding with the flipped LLR sequence (f₀, f₁, . . . , fₙ₋₁) to generate a decoded sequence d=(d₀, d₁, . . . , dₙ₋₁).
b. Calculate CS with LDPC decoder 915 using the bit sequence d.
c. IF CS==0 or iter==ITER_Max:
   Terminate decoding
END
d. IF CS<a predetermined threshold α && iter >a predetermined threshold β && iter % γ==0:
Generate by scrambler 917 a sequence r=(r₀, r₁, . . . , rₙ₋₁) based on the decoded data d=(d₀, d₁, . . . , dₙ₋₁), where r=bitwise_xor (d, s)
   Compute by bucket counter 911 the numbers B (0, 0), B (1, 0), B (0, 1), B (1, 1), . . . , B (0, K-1), and B (1, K-1) where
   B (0, j) is the number of positions in sequences r and b such that rᵢ=0 and bᵢ=j, i=0, 1, . . . , . . . , n−1, j=0, 1, . . . , . . . , K−1
   B (1, j) is the number of positions in sequences r and b such that rᵢ=1 and bᵢ=j, i=0, 1, . . . , . . . , n−1, j=0, 1, . . . , . . . , K−1
   Generate with bucket counter 911

$${LLR}_{j} = ( Log ( \frac{B ( 0 , j )}{B ( 1 , j )} ) ) ,$$

j=0, 1, . . . , . . . , K−1
   Update at LLR generator 909 the LLR sequence l=(l₀, l₁, . . . , lₙ₋₁) by applying the updated LLR₀, LLR₁, . . . , LLR_{K-1} to the bin label sequence b as follows:

For i = 0: n−1
lᵢ = LLR_{b}_{ᵢ}
END

Update at LLR sign flipper 913 the flipped LLR sequence f=(f₀, f₁, . . . , fₙ₋₁) as follows:

```
    For i = 0: n−1
      IF scrambling sequence bit sᵢ = = 1 : fᵢ = −
      lᵢ
      ELSE: fᵢ = lᵢ
      END
    END
  END
END
```

As demonstrated above, a self-adaptation LDPC min-sum soft decoder is provided for where the LLR value of each bin label is adjusted during the decoding progress. This self-adaptation can work with NAND soft reads with or without assist reads. This self-adaptation can work with decoders having REN or ERN architectures.

### Inventive Method

In one embodiment of the present disclosure, there is provided a method for decoding data read from a storage of a memory system. This method can be programmed into memory controller 100, or in control unit 120 of memory controller 100, or in control circuit 200 of semiconductor memory device 200. At 1401, this method reads the data stored in the storage of the memory system with read voltages spanning a range of voltage threshold distributions and including voltages within each of the voltage threshold distributions. At 1403, this method divides the range into bins spanning the range (the bins may be bounded by two of the read voltages). At 1405, this method generates initial log likelihood ratio values for each bin and generating a bin sequence bn of bin positions. At 1407, this method adjusts values of the initial log likelihood ratio values for each bin to provide adjusted log likelihood ratio values for each bin prior to a final decoding of the data read from the storage.

In one embodiment, the generating initial log likelihood ratio values for each bin may comprise generating a channel log likelihood ratio sequence In for decoding data read from the storage.

In one embodiment, the adjusting the log likelihood ratio values for each bin may comprise a) conducting low density parity check (LDPC) min-sum decoding with the initial log likelihood ratio values, and thereby generating an intermediate decoded sequence; b) calculating a checksum on the intermediate decoded sequence; c) if the checksum of the intermediate decoded sequence is zero, terminating decoding of the data read from the storage; d) if the checksum of the intermediate decoded sequence dᵢ is not zero, generating updated log likelihood ratio values based on values in the intermediate decoded sequence dᵢ; and e) using the updated log likelihood ratio values as the channel log likelihood ratio sequence for decoding of the data read from the storage.

In one embodiment, the generating of the updated log likelihood ratio values may comprise calculating log likelihood ratios at a) a number of positions in the intermediate decoded sequence and the bin label sequence with pattern (0, j) and b) a number of positions in the intermediate decoded sequence and the bin label sequence with pattern (1, j).

In the above embodiment, the calculating of a log likelihood ratio may utilize a bucket counter for counting a) the number of positions in the intermediate decoded sequence and the bin label sequence with the pattern (0, j) and b) the number of positions in the intermediate decoded sequence and the bin label sequence with the pattern (1, j).

In one embodiment, the method may further comprise receiving the data to be stored in the storage, scrambling the data, then encoding the data, and thereafter storing the data in the storage.

In one embodiment, the method may further comprise receiving the data to be stored in the storage, encoding the data, then scrambling the data, and thereafter storing the data in the storage.

In one embodiment, the method may further comprise flipping a sign of the initial log likelihood ratio values, decoding the data with the initial log likelihood ratio values to produce an intermediate decoded sequence, and scrambling the intermediate decoded sequence prior to the adjusting values of the initial log likelihood ratio values.

In one embodiment, the adjusted log likelihood ratio values for each bin can match the voltage threshold distributions. In one embodiment, the adjusted log likelihood ratio values for each bin can match the voltage threshold distributions as the storage is used over time.

### Memory System

In another embodiment of the present invention, there is provided a memory system (such memory system 2 in FIG. 1) having a storage (such as for example storage system 10 in FIG. 1) for storing data therein; an encoder (such as for example LDPC encoder 5 in FIG. 1) for encoding the data prior to storing the data in the storage; a decoder (such as for example LDPC decoder 15 in FIG. 1) for decoding the data after the data is read from the storage; and a controller (such as memory controller 100 in FIG. 2) for controlling processing of the data read from the storage.

The controller is configured to read the data stored in the storage of the memory system, with read voltages spanning a range of voltage threshold distributions and including voltages within each of the voltage threshold distributions. The controller is further configured to divide the range into bins spanning the range; generate initial log likelihood ratio values for each bin and produce a bin sequence bn of bin positions; and adjust values of the initial log likelihood ratio values for each bin to provide adjusted log likelihood ratio values for each bin prior to a final decoding of the data read from the storage.

In one embodiment, the controller can be configured to generate a channel log likelihood ratio sequence for decoding data read from the storage.

In one embodiment, the controller can be configured to a) conduct low density parity check (LDPC) min-sum decoding with the initial log likelihood ratio values LLRk, and thereby generate an intermediate decoded sequence; b) calculate a checksum on the intermediate decoded sequence; c) if the checksum of the intermediate decoded sequence dᵢ is zero, terminate decoding of the data read from the storage; d) if the checksum of the intermediate decoded sequence dᵢ is not zero, generate updated log likelihood ratio values based on values in the intermediate decoded sequence; and e) use the updated log likelihood ratio values as the channel log likelihood ratio sequence for decoding of the data read from the storage.

In one embodiment, the controller can be configured to calculate log likelihood ratios at a) a number of positions in the intermediate decoded sequence and the bin label sequence with pattern (0, j) and b) a number of positions in the intermediate decoded sequence and the bin label sequence with pattern (1, j).

In the above embodiment, the memory system may further have a bucket counter configured to count a) the number of positions in the intermediate decoded sequence and the bin label sequence with the pattern (0, j) and b) the number of positions in the intermediate decoded sequence and the bin label sequence with the pattern (1, j).

In one embodiment, the memory system may further have a scrambler disposed before the encoder, and the controller can be configured to read the data, scramble the data, then encode the data, and thereafter store the data in the storage. In one embodiment, the memory system may further have a scrambler disposed after the encoder, and wherein the controller can be configured to read the data, encode the data, then scramble the data, and thereafter store the data in the storage. In this embodiment, the controller can be configured to a) flip a sign of the initial log likelihood ratio values, b) decode the data with the initial log likelihood ratio values to produce an intermediate decoded sequence, and c) scramble the intermediate decoded sequence prior to the adjusting values of the initial log likelihood ratio values.

In one embodiment, the adjusted log likelihood ratio values for each bin match the voltage threshold distributions. In another embodiment the adjusted log likelihood ratio values for each bin match the voltage threshold distributions as the storage is used over time.

Although the foregoing embodiments have been described in some detail for purposes of clarity of understanding, the invention is not limited to the details provided. There are many alternative ways of implementing the invention. The disclosed embodiments are illustrative and not restrictive. The present invention is intended to embrace all modifications and alternatives of the disclosed embodiment. Furthermore, the disclosed embodiments may be combined to form additional embodiments.

Indeed, implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for decoding data read from a storage of a memory system, comprising:
reading the data stored in the storage of the memory system with read voltages spanning a range of voltage threshold distributions and including voltages within each of the voltage threshold distributions;
dividing the range into bins spanning the range;
generating initial log likelihood ratio values for each bin and generating a bin sequence of bin positions; and
adjusting values of the initial log likelihood ratio values for each bin to provide adjusted log likelihood ratio values for each bin prior to a final decoding of the data read from the storage.

2. The method of claim 1, wherein the generating initial log likelihood ratio values for each bin comprises generating a channel log likelihood ratio sequence for decoding data read from the storage.

3. The method of claim 2, wherein the adjusting the log likelihood ratio values for each bin comprises:
a) conducting low density parity check (LDPC) min-sum decoding with the initial log likelihood ratio values, and thereby generating an intermediate decoded sequence;
b) calculating a checksum on the intermediate decoded sequence;
c) if the checksum of the intermediate decoded sequence is zero, terminating decoding of the data read from the storage;
d) if the checksum of the intermediate decoded sequence is not zero, generating updated log likelihood ratio values based on values in the intermediate decoded sequence; and
e) using the updated log likelihood ratio values as the channel log likelihood ratio sequence for decoding of the data read from the storage.

4. The method of claim 3, wherein the generating updated log likelihood ratio values comprises:
calculating log likelihood ratios at a) a number of positions in the intermediate decoded sequence and the bin label sequence with pattern (0, j) and b) a number of positions in the intermediate decoded sequence and the bin label sequence with pattern (1, j).

5. The method of claim 4, wherein the calculating a log likelihood ratio utilizes a bucket counter for counting a) the number of positions in the intermediate decoded sequence and the bin label sequence with the pattern (0, j) and b) the number of positions in the intermediate decoded sequence and the bin label sequence with the pattern (1, j).

6. The method of claim 1, further comprising receiving the data to be stored in the storage, scrambling the data, then encoding the data, and thereafter storing the data in the storage.

7. The method of claim 1, further comprising receiving the data to be stored in the storage, encoding the data, then scrambling the data, and thereafter storing the data in the storage.

8. The method of claim 7, further comprising:
flipping a sign of the initial log likelihood ratio values;
decoding the data with the initial log likelihood ratio values to produce an intermediate decoded sequence, and
scrambling the intermediate decoded sequence prior to the adjusting values of the initial log likelihood ratio values.

9. The method of claim 1, wherein the adjusted log likelihood ratio values for each bin match the voltage threshold distributions.

10. The method of claim 1, wherein the adjusted log likelihood ratio values for each bin match the voltage threshold distributions as the storage is used over time.

11. A memory system, comprising:
a storage for storing data therein;
an encoder for encoding the data prior to storing the data in the storage;
a decoder for decoding the data after the data is read from the storage; and
a controller for controlling processing of the data read from the storage, the controller configured to:
read the data stored in the storage of the memory system with read voltages spanning a range of voltage threshold distributions and including voltages within each of the voltage threshold distributions;
divide the range into bins spanning the range;
generate initial log likelihood ratio values for each bin and producing a bin sequence of bin positions; and
adjust values of the initial log likelihood ratio values for each bin to provide adjusted log likelihood ratio values for each bin prior to a final decoding of the data read from the storage.

12. The memory system of claim 11, wherein the controller is configured to generate a channel log likelihood ratio sequence for decoding data read from the storage.

13. The memory system of claim 12, wherein the controller is configured to:
a) conduct low density parity check (LDPC) min-sum decoding with the initial log likelihood ratio values, and thereby generate an intermediate decoded sequence;
b) calculate a checksum on the intermediate decoded sequence dᵢ;
c) if the checksum of the decoded sequence dᵢ is zero, terminate decoding of the data read from the storage;
d) if the checksum of the intermediate decoded sequence is not zero, generate updated log likelihood ratio values based on values in the intermediate decoded sequence; and
e) use the updated log likelihood ratio values as the channel log likelihood ratio sequence for decoding of the data read from the storage.

14. The memory system of claim 13, wherein the controller is configured to:
calculate log likelihood ratios at a) a number of positions in the intermediate decoded sequence and the bin label sequence with pattern (0, j) and b) a number of positions in the intermediate decoded sequence and the bin label sequence with pattern (1, j).

15. The memory system of claim 14, further comprising a bucket counter configured to count a) the number of positions in the intermediate decoded sequence and the bin label sequence with pattern (0, j) and b) the number of positions in the intermediate decoded sequence and the bin label sequence with pattern (1, j).

16. The memory system of claim 15, further comprising a scrambler disposed before the encoder, and wherein the controller is configured to:
read the data, scramble the data, then encode the data, and thereafter store the data in the storage.

17. The memory system of claim 15, further comprising a scrambler disposed after the encoder, and wherein the controller is configured to:
read the data, encode the data, then scramble the data, and thereafter store the data in the storage.

18. The memory system of claim 17, wherein the controller is configured to:
flip a sign of the initial log likelihood ratio values;
decode the data with the initial log likelihood ratio values to produce an intermediate decoded sequence and
scramble an intermediate decoded sequence prior to the adjusting values of the initial log likelihood ratio values.

19. The memory system of claim 11, wherein the adjusted log likelihood ratio values for each bin match the voltage threshold distributions.

20. The memory system of claim 11, wherein the adjusted log likelihood ratio values for each bin match the voltage threshold distributions as the storage is used over time.
